(19) United States
(12) Patent Application Publication
(10) Pub. No.: US 2024/0190182 A1
(43) Pub. Date: Jun. 13, 2024

(54) PNEUMATIC TIRE

(71) Applicant: Toyo Tire Corporation, Itami-shi (JP)

(72) Inventor: Yoshiki Sato, Itami-shi (JP)

(73) Assignee: Toyo Tire Corporation, Itami-shi (JP)

(21) Appl. No.: 18/527,709

(22) Filed: Dec. 4, 2023

(30) Foreign Application Priority Data
Dec. 8, 2022 (JP) 2022-196342

(51) Int. Cl. B60C 13/00

(52) U.S. Cl. CPC B60C 13/001

(57) ABSTRACT

A tire 1 includes at least one mark 4 on a sidewall 2. The mark 4 includes an outer surface including one or more and four or fewer elongated first protrusions 18 having a trapezoidal or substantially trapezoidal cross section that is orthogonal to a traveling direction of the tire 1. The mark 4 may include one or more circular second protrusions 15 and 16 protruding axially outward on an entire edge of the mark 4 to fringe the mark 4.

### CROSS REFERENCE TO RELATED APPLICATION

This application claims priority to Japanese Patent Application No. 2022-196342 filed on Dec. 8, 2022, which is incorporated herein by reference in its entirety including the specification, claims, drawings, and abstract.

### TECHNICAL FIELD

The present disclosure relates to a pneumatic tire.

### BACKGROUND

A pneumatic tire disclosed in JP 2019-147495 A is known. The pneumatic tire includes a mark disposed on a sidewall face of the tire, and the mark at least partially includes saw-tooth serrations of a plurality of ridges arranged in parallel. This pneumatic tire, including the mark having serrations with short pitches and different angles, allows light that irradiates the mark to be reflected in a large number of different directions. This generates variations of light and shadow parts on the mark to thereby allow the mark to be conspicuous.

### SUMMARY

In the above-described pneumatic tire, the mark having serrations with short pitches is likely to be clogged with mud while a vehicle is traveling on a muddy road. This deteriorates legibility of characters and also makes it difficult to clean off a dirt from the tire. An embodiment of the disclosure is therefore aimed toward providing a pneumatic tire having a conspicuous mark which is not easily clogged with mud.

To resolve the above problem, the pneumatic tire according to the present disclosure includes at least one mark on a sidewall of the pneumatic tire, and the at least one mark includes an outer surface including one or more and four or fewer elongated first protrusions having a trapezoidal cross sectional shape that is orthogonal to a traveling direction of the pneumatic tire.

Alternatively, the pneumatic tire according to the present disclosure includes at least one mark on a sidewall of the pneumatic tire, and the at least one mark includes an outer surface including one or more and four or fewer elongated first protrusions having a substantially trapezoidal cross sectional shape that is orthogonal to a traveling direction of the pneumatic tire

The substantially trapezoidal cross sectional shape that is orthogonal to the traveling direction of the pneumatic tire includes a cross sectional shape having at least one chamfered angle among four angles of a trapezoid in the cross section, and the at least one chamfered angle is formed of a curved face outwardly protruding of the angle. The substantially trapezoidal cross sectional shape orthogonal to the traveling direction further includes a cross sectional shape including, among three sides (upper side, first slope side, second slope side) of a trapezoid in the cross section, at least one side that is a curved line, not a straight line. The substantially trapezoidal cross sectional shape orthogonal to the traveling direction also includes a cross sectional shape having, among four angles of a trapezoid in the cross section, at least one chamfered angle that forms an outwardly protruding curved face, and also including, among three sides (upper side, first slope side, second slope side) of the trapezoid in the cross section, at least one side that is a curved line, not a straight line.

The configuration of the pneumatic tire according to the present disclosure allows a mark to look conspicuous while preventing the mark from being easily clogged with mud.

### BRIEF DESCRIPTION OF DRAWINGS

The figures depict one or more implementations in accordance with the present teaching, by way of example only, not by way of limitations. In the figures, like reference numerals refer to the same or similar elements.

Embodiments of the present disclosure will be described based on the following figures, wherein:

FIG. 1 is a perspective view of a tire according to one embodiment of the disclosure, illustrating one side of the tire viewed from diagonally above;

FIG. 2 is a perspective view of a mark display region viewed from diagonally below in the axially outward direction;

FIG. 3 is a perspective sectional view taken along line A-A in FIG. 2, which is a schematic cross sectional view of a region between the left end of a mark representing R in the extending direction of a plurality of elongated first protrusions and the inner edge of the mark, the region being cut with a plane including an arranging direction of the first protrusions and an axial direction;

FIG. 4 is a perspective sectional view taken along line B-B in FIG. 2, which is a perspective cross sectional view of a configuration created by cutting a region enclosed by an inner edge of the mark representing R in the extending direction of the first protrusions, in the vicinity of the center, with a plane including the arranging direction of the first protrusions and the axial direction, when viewed from a slightly slanted axial direction;

FIG. 5 is a schematic cross sectional view of a tire according to a first modification example, which corresponds to FIG. 3;

FIG. 6 is a perspective view of a tire according to a second modification example, which corresponds to FIG. 2;

FIG. 7 is a schematic cross sectional view of a tire according to a third modification example, which corresponds to FIG. 3;

FIG. 8 is a schematic cross sectional view of a tire according to a fourth modification example, which corresponds to FIG. 3;

FIG. 9 is a schematic cross sectional view of a tire according to a fifth modification example, which corresponds to FIG. 3;

FIG. 10 is a schematic cross sectional view of a tire according to a sixth modification example, which corresponds to FIG. 3;

FIG. 11 is a schematic cross sectional view illustrating a shape of the first protrusion of a tire according to a seventh modification example; and

FIG. 12 is a schematic cross sectional view illustrating a shape of the first protrusion of a tire according to an eighth modification example.

### DESCRIPTION OF EMBODIMENTS

Embodiments of the disclosure will be described in detail below by reference to the drawings. It is expected that, features of a plurality of embodiments and modification examples described below may be combined as appropriate to constitute new embodiments. In the following examples, identical elements are denoted with the same reference numerals and will not be explained repeatedly. A plurality of drawings include schematic views, and the dimensional ratios between the vertical length, horizontal length, and height, for example, of marks in different drawings are not always the same. Among the elements described below, elements that are not recited in independent claims representing the most superordinate concept are optional, not essential. In the following description, a “pneumatic tire” will be simply referred to as a “tire”.

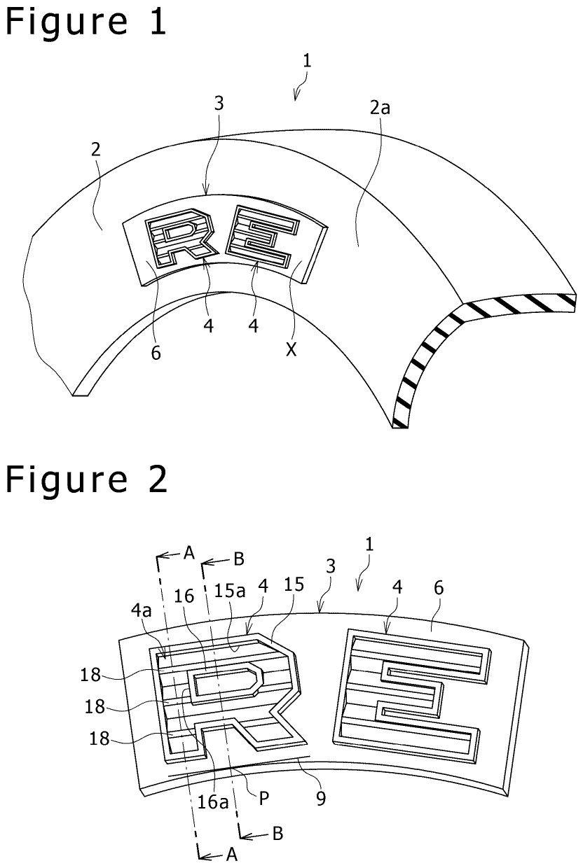

FIG. 1 is a perspective view of a tire 1 according to an embodiment of the disclosure, and illustrates one side of the tire 1 viewed from diagonally above. As illustrated in FIG. 1, the tire 1 includes at least one mark display region 3 on at least one sidewall 2. The sidewall 2 is on a side of the tire 1, and has a site where the tire 1 is most flexible. The sidewall 2 is smoothly bendable and is resistant to impacts and a centrifugal force.

The mark display region 3 includes a base face X on a top face 2a of the sidewall 2, and one or more marks 4 disposed on the base face X. The mark display region 3 has a seat 6 protruding from the top face 2a of the sidewall 2 to a predetermined height, and a top surface of the seat 6 functions as the base face X. The thickness direction of the seat 6 substantially corresponds to the axial direction of the tire 1.

The seat 6 may be omitted; in this configuration, the top face 2a of the sidewall 2 functions as the base face X. The mark 4 includes characters, such as characters representing the name of the manufacturer, brand name, tire size, aspect ratio, week of the year of manufacture of the tire, or includes symbols such as speed signs and figures. In this embodiment, a brand name including a plurality of marks 4 is shown on the base face X.

FIG. 2 is a perspective view of the mark display region 3 viewed from diagonally below in the axially outward direction. As illustrated in FIG. 2, the mark 4 includes an outer surface including one or more and four or fewer elongated first protrusions 18 having a trapezoidal cross section that is orthogonal to the traveling direction of the tire 1. More specifically, the outer surface of the mark 4 includes three first protrusions 18 having a substantially isosceles trapezoidal cross section and linearly extending in parallel to each other. The three first protrusions 18 extend in a direction along the circumferential direction, and are opposed to one another in the arranging direction that is slanted from the radial direction of the mark 4 by 10° or less. The first protrusion 18 includes a linear edge. The direction along the circumferential direction described above is defined as a direction that is slanted at 10° or less relative to a circumferential tangent 9 at a center position P between a first circumferential end of the mark 4 and a second circumferential end of the mark 4. The radial direction of the mark 4 is defined as the radial direction of the tire 1 that passes the center position P between the first circumferential end of the mark 4 and the second circumferential end of the mark 4.

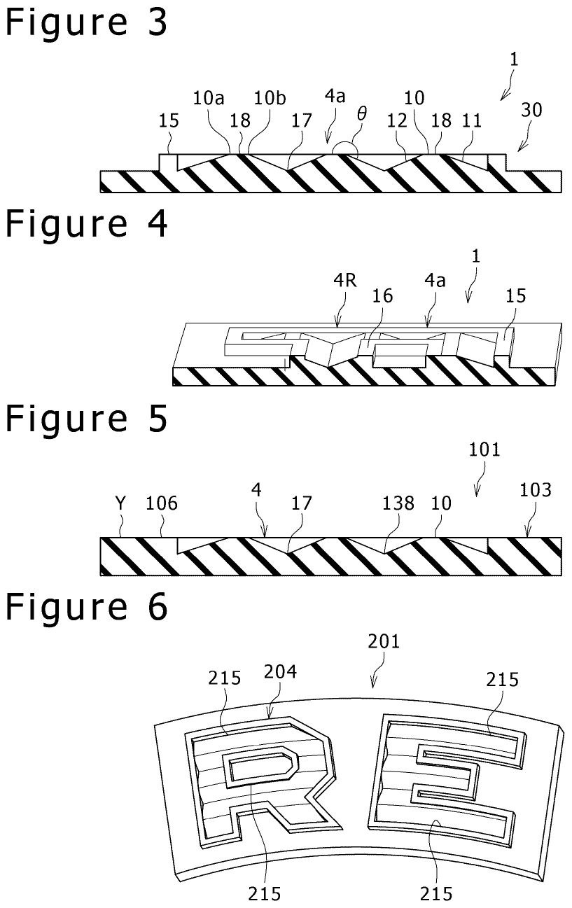

FIG. 3 is a perspective cross sectional view taken along line A-A in FIG. 2, which is a schematic cross sectional view of a region between the left end of the mark 4a representing R in the extending direction of the first protrusions 18 and the inner edge 16a (see FIG. 2) of the mark 4a, which region is cut with a plane including the arranging direction of the first protrusions and the axial direction. In this embodiment, the axial direction substantially corresponds to the thickness direction of the seat 6. As illustrated in FIG. 3, the first protrusion 18 includes a tip face 10, a first slope face 11, and a second slope face 12. The tip face 10 has a strip shape (elongated shape) defined by two edges 10a and 10b extending substantially in parallel. The first slope face 11 extends axially inward, from a first edge 10a of the tip face 10 in the arranging direction, as the slope face 11 extends further toward a first side in the arranging direction from the first edge 10a. The second slope face 12 extends axially inward, from a second edge 10b of the tip face 10 in the arranging direction, as the slope face 12 extends toward a second side, opposite the first side, in the arranging direction from the second edge 10b. Each of the tip face 10, the first slope face 11, and the second slope face 12 is a flat face. In this embodiment, the angle θ formed by the first slope face 11 with respect to the tip face 10 is substantially equal to the angle formed by the second slope face 12 with respect to the tip face 10.

FIG. 4 is a perspective cross sectional view taken along line B-B in FIG. 2, which is a perspective cross sectional view of a configuration created by cutting a region enclosed by the inner edge 16a of the mark 4a representing R in the extending direction of the first protrusions 18, in the vicinity of the center, with a plane including the arranging direction of the first protrusions 18 and the axial direction, when viewed from a slightly slanted axial direction.

As illustrated in FIGS. 2 to 4, one or more circular second protrusions 15 and 16 protruding axially outward are disposed at the entire edges of the mark 4 to fringe the mark 4. The mark 4a representing R includes an outer circular protrusion 15 fringing the entire circumference of an outer edge 15a, and an inner circular protrusion 16 fringing the entire circumference of an inner edge 16a. The outer circular protrusion 15 and the inner circular protrusion 16 are included in the one or more circular second protrusions. Referring to FIG. 3, an absolute value of a difference between the axial position of the tip face 10 at the axially outermost site of the mark 4 and the axial positions of the axially outermost sites of the one or more circular second protrusions 15 and 16 may be an arbitrary value. However, such an absolute value of 5 mm or less achieves an enhanced aesthetical view of the mark 4, and the mark 4 with the absolute value of 3 mm or less provides a particularly enhanced aesthetical view, and a stylish mark 4 is achieved.

The axial distance between the axial position of the tip face 10 at the axially outermost location of the mark 4, and the axial position of a valley 17 that is located between two adjacent first protrusions 18 and corresponds to the position of an intersection point between bases of two adjacent slope faces; that is, the first slope face 11 and the second slope face 12, may be an arbitrary distance. However, the mark 4 with the axial distance of 3 mm or greater between the axial position of the tip face 10 and the axial position of the valley 17 has an improved three-dimensional property, resulting in a conspicuous mark 4. The mark 4 with the axial distance of 1 mm or less between the axial position of the tip face 10 and the axial position of the valley 17 prevents clogging of the mark with mud.

FIG. 5 is a cross sectional view of a tire 101 according to a first modification example and corresponds to FIG. 3. As illustrated in FIG. 5, a mark display region 103 disposed on a sidewall includes a seat 106 protruding from the top face of the sidewall to a predetermined height, and the top face of the seat 106 functions as a base face Y.

The seat 106 includes a depression 138 having a substantially constant depth, and one or more marks 4 are disposed on the bottom face of the depression 138. In this configuration, when the mark 4 has an inner edge as in the mark 4a representing R, the axial position of the outer surface of the region enclosed with the inner edge may be located further axially outward than the axial position of the base face Y. However, in some embodiments in which the mark 4 has an inner edge as in the mark 4a representing R, the axial position of the outer surface of the region enclosed with the inner edge may be substantially level with the axial position of the base face Y. The seat 106 may be omitted; in this configuration, the top face of the sidewall functions as the base face, and the top face of the sidewall includes a depression having a substantially constant depth and the one or more marks 4 are disposed on the bottom face of the depression.

Referring to FIG. 5, the absolute value of a difference between the axial position of the base face Y and the axial position of the tip face 10 at the axially outermost site of the mark 4 may be an arbitrary value. However, such an absolute value of 3 mm or less achieves an enhanced aesthetical view of the mark 4, and the mark with the absolute value of 5 mm or less provides the mark 4 with a particularly enhanced aesthetical view, and therefore a stylish mark 4 is achieved.

The axial distance between the axial position of the tip face 10 and the axial position of the valley position 17 may have an arbitrary value. However, in this modification example, similar to the above example, the mark 4 with the axial distance of 3 mm or greater provides an improved three-dimensional property, resulting in a conspicuous mark 4. The mark 4 with the axial distance of 1 mm or less prevents clogging with mud.

FIG. 6 is a perspective view of a tire 201 according to a second modification example, which corresponds to FIG. 2. As illustrated in FIG. 6, a mark 204 may include an outer surface including one or more and four or fewer elongated first protrusions 218 having a trapezoidal sectional shape that is orthogonal to the traveling direction and extending circumferentially in parallel to each other. The outer surface of the mark 204 may further include an arc-shaped edge 215 extending in parallel to the circumferential direction of the tire 201.

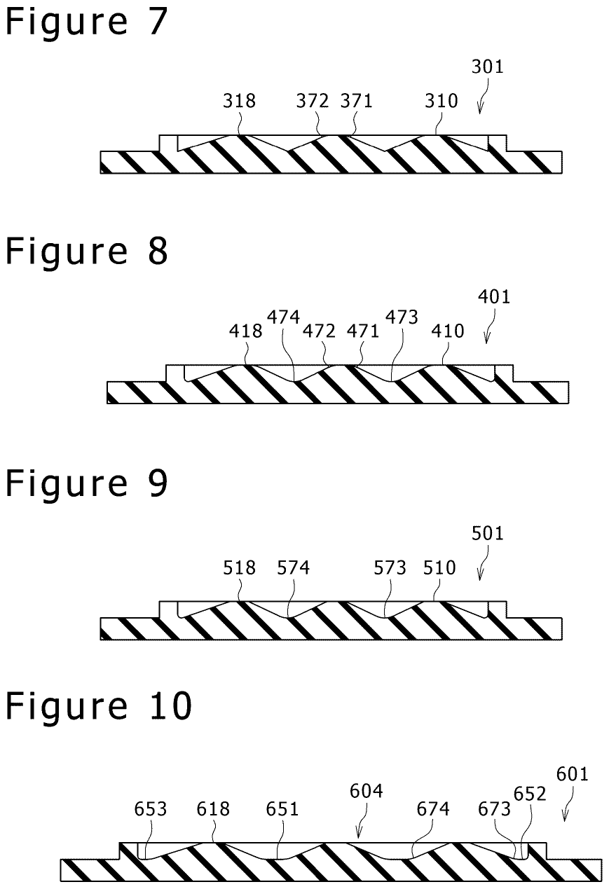

FIG. 7 is a schematic cross sectional view of a tire 301 according to a third modification example, which corresponds to FIG. 3, and FIG. 8 is a schematic cross sectional view of a tire 401 according to a fourth modification example, which corresponds to FIG. 3. FIG. 9 is a schematic cross sectional view of a tire 501 according to a fifth modification example, which corresponds to FIG. 3, and FIG. 10 is a schematic cross sectional view of a tire 601 according to a sixth modification example, which corresponds to FIG. 3.

While in the above embodiments, the first protrusion 18, 218 has a trapezoidal cross section that is orthogonal to the traveling direction, the first protrusion may have a substantially trapezoidal cross section that is orthogonal to the traveling direction. Specifically, the first protrusion 318 may have a cross sectional shape that is orthogonal to the traveling direction as illustrated in FIG. 7; among four corners of a trapezoid, two corners located at opposite widthwise edges of an elongated tip face 310 that is a flat face, are chamfered, and the chamfered corners form outwardly protruding curved faces 371 and 372, respectively.

Further, as illustrated in FIG. 8, a first protrusion 418 may have a cross sectional shape that is orthogonal to the traveling direction, which includes, in addition to the two chamfered corners at opposite widthwise edges of an elongated tip face 410 that is a flat face, two additional chamfered corners at the base of the trapezoid, thereby forming outwardly protruding curved faces 471, 472, 473, and 474 disposed outward of these four chamfered corners of the trapezoid. Further, as illustrated in FIG. 9, a first protrusion 518 may have a cross sectional shape that is orthogonal to the traveling direction, including outwardly protruding curved faces 573 and 574 disposed outward of two chamfered corners of a trapezoid at the base of the trapezoid, among the four corners of the trapezoid.

Further, as illustrated in FIG. 10, a first protrusion 618 may have a cross sectional shape that is orthogonal to the traveling direction, including outwardly protruding curved faces 673 and 674 disposed outward of two chamfered corners of a trapezoid located at the base of the trapezoid, among the four corners of the trapezoid. A mark 604 may further include an outer surface having a strip-like (elongated) flat face 651 between two adjacent first protrusions 618 in the arranging direction of a plurality of first protrusions 618.

The outer surface of the mark 604 may further include a strip-like (elongated) flat face 652 connecting with the base on a first end side of the first protrusion 618 in the arranging direction, located at a first end in the arranging direction of a plurality of first protrusions 618. The outer surface of the mark 604 may further include a strip-like (elongated) flat face 653 connecting with the base on a second end side, opposite the first end side, of the first protrusion 618 in the arranging direction, located at a second end, opposite the first end, in the arranging direction of the plurality of first protrusions 618.

The outer surface of the mark may include only one elongated first protrusion having a trapezoidal cross sectional shape that is orthogonal to the traveling direction. The outer surface of the mark may include two or more and four or fewer elongated first protrusions having a trapezoidal cross sectional shape that is orthogonal to the traveling direction. In this configuration, the two or more and four or fewer first protrusions may have substantially the same cross sectional shape and substantially the same cross sectional area. In the configuration of the mark including the outer surface with three or more elongated first protrusions having a trapezoidal cross sectional shape that is orthogonal to the traveling direction and also including a strip-like (elongated) flat face between bases of two adjacent first protrusions in the arranging direction, the strip-like flat faces may have the same width.

However, in some embodiments, not all of the two or more and four or fewer first protrusions have the same cross sectional shape or the same cross sectional area. Further, in some embodiments, in the configuration of the mark including the outer surface with three or more elongated first protrusions having a trapezoidal cross sectional shape orthogonal to the traveling direction and also including a strip-like (elongated) flat face between bases of two adjacent first protrusions in the arranging direction, not all of the strip-like faces have the same width.

### Basic Configurations

As described above, the tire 1, 101, 201 includes the at least one mark 4, 204 on the sidewall 2. The outer surface of the mark 4, 204 includes the one or more and four or fewer elongated first protrusions 18 having a trapezoidal cross sectional shape that is orthogonal to the traveling direction of the tire 1, 101, 201.

The mark 4, 204 according to the disclosure includes an outer surface including at most only four elongated first protrusions 18 having a trapezoid cross section that is orthogonal to the traveling direction, and thus includes the much smaller number of faces than the mark disclosed in JP 2019-147495 A, including serrations with short pitches and different angles. The configuration of the mark 4, 204 according to the disclosure therefore effectively prevents mud clogging of the mark 4, 204.

The outer surface of the mark 4, 204 includes the first protrusion 18 having a trapezoidal cross sectional shape that is orthogonal to the traveling direction. This configuration causes light reaching the outer surface of the mark 4, 204 to be reflected in a complicated manner, thereby making the mark 4, 204 conspicuous.

The tire 301, 401, 501, 601 may include, on the sidewall of the tire, at least one mark 604 including an outer surface having one or more and four or fewer elongated first protrusions 318, 418, 518, 618 having a substantially trapezoidal cross section, not a trapezoidal cross section, that is orthogonal to the traveling direction.

The substantially trapezoidal cross sectional shape orthogonal to the traveling direction includes a cross sectional shape with at least one of four corners of the trapezoid being chamfered to form a curved face protruding outward of the chamfered corner.

As illustrated in FIG. 7, for example, the cross section of the first protrusion 318 orthogonal to the traveling direction may be a cross sectional shape including outwardly protruding curved faces 371 and 372 disposed outside the two chamfered corners at opposite edges in the width direction of the elongated tip face 310 formed of a flat face, among the four corners of the trapezoid.

Further, as illustrated in FIG. 8, the cross section of the first protrusion 418 orthogonal to the traveling direction may have a shape including outwardly protruding curved faces 471, 472, 473, 474 disposed outside the four chamfered corners of a trapezoid, respectively, which are, in addition to two chamfered corners at opposite edges in the width direction of the tip face 410 formed of a flat face, the two corners at the base of the trapezoid.

As illustrated in FIG. 9 and FIG. 10, the cross section of the first protrusion 518, 618 that is orthogonal to the traveling direction may have a shape including outwardly protruding curved faces 573 and 574, and 673 and 674, respectively, disposed outside the two chamfered corners at the base of a trapezoid, of the four corners of the trapezoid.

Each of the tires 301, 401, 501, and 601 illustrated in FIGS. 7 to 10, similar to the tire 1, 101, 201, includes an extremely smaller number of faces, to thereby prevent clogging of the mark 4, 204 with mud. The mark 4, 204 includes an outer surface including the first protrusions 18 having a substantially trapezoidal cross section orthogonal to the traveling direction, which causes the light reaching the outer surface of the mark 4, 204 to be reflected in a complicated manner, thereby making the marks 4 and 204 conspicuous.

In addition, the tire 301, 401 includes the outwardly protruding curved faces 371 and 372 disposed outside the two chamfered corners at the opposite edges of the elongated tip face, 310, 410 in the width direction. This configuration prevents damage of the two corners of the elongated tip face 310, 410 at opposite edges in the width direction and also prevents cracks and small defects of the two corners, thus increasing resistance to chipping.

The configuration without curved faces at the base of the first protrusion is likely to cause the corners at the bottom of the groove to be clogged with mud and thus causes concentration of stress on the corners. The tire 401, 501, 601 according to the disclosure includes the first protrusion 418, 518, 618 having curved faces 473 and 474, 573 and 574, and 673 and 674 at the corners at the base. This configuration not only prevents adhesion of mud to the corners at the base of the first protrusion 418, 518, 618, but also reduces the stress generated at the corners at the base, thereby increasing anti-cracking properties.

### Optional Configurations

As illustrated in FIG. 1 to FIG. 4, and FIG. 6, the mark 4, 404 may include the circular second protrusions 15 and 16 protruding axially outward around the entire edge to fringe the mark 4, 404 with one or more circular second protrusions 15 and 16.

This configuration of the mark 4, 404 including the entire edge fringed with the circular second protrusions 15 and 16 provides steps by the inner faces of the circular second protrusions 15 and 16 adjacent to the mark. These steps make the mark 4, 404 conspicuous and increase legibility of the mark 4, 404.

Further, as illustrated in FIG. 5, the sidewall may include the base face Y and the depression 138 disposed on the base face Y, and the mark 4 may be disposed on the bottom face of the depression 138.

This configuration including the mark 4 at the bottom face of the depression 138 limits the position of an air pocket that may be generated during vulcanization molding of tire 101 to the bottom face of a side face of the depression 138 that does not significantly affect the aesthetic view of the mark 4, and a vent hole for air vent is disposed at the bottom of a side edge of the depression 138 that does not significantly affect the aesthetic view of the mark 4. The configuration including the mark 4 at the bottom face of the depression 138 further reduces deficiencies of rubber flow to thereby reduce generation of the air pocket itself, resulting in a clear mark 4 which is easy for humans to visually recognize.

The mark 4, 4a, 204, 604 may include an outer surface including the plurality of first protrusions 18, 318, 418, 518, 618. These first protrusions 18, 318, 418, 518, 618 may be opposite one another in a direction slanted at 10° or less relative to the radial direction of the mark 4, 4a, 204, 604.

This configuration allows the first protrusions 18, 318, 418, 518, 618 to extend in a direction parallel or substantially parallel to the circumferential direction. This makes it easy to increase the length of the first protrusions 18, 318, 418, 518, 618 in the extending direction, making the first protrusions 18, 318, 418, 518, 618 conspicuous.

As illustrated in FIG. 6, the mark 204 including the first protrusions 218 extending substantially in parallel to the circumferential direction of the tire 201 and the edge 215 extending in parallel to the circumferential direction of the tire 201 has an improved design property, achieving the mark 204 with an enhanced aesthetic view.

As illustrated in FIG. 10, the configuration of the mark 601 including a strip-like (elongated) flat face 651 between the bases of two of the plurality of first protrusions 618 adjacent to each other in the arranging direction further prevents adhesion of mud to the bases of the first protrusions 618.

The configuration including the strip-like (elongated) flat face 652 connected to the base on the first end side of the first protrusion 618 in the arranging direction, disposed at the first end in the arranging direction of the plurality of first protrusions 618, also prevents adhesion of mud in the vicinity of the base on the first end side.

The configuration including the strip-like (elongated) flat face 653 connected to the base on the second end side, opposite the first end side, of the first protrusion 618 in the arranging direction, disposed at the second end, opposite the first end, in the arranging direction of the plurality of first protrusions 618, also prevents adhesion of mud in the vicinity of the base on the second end side.

### OTHER MODIFICATION EXAMPLES

The present disclosure is not limited to the embodiments and their modification examples described above, and various improvements and changes may be made within the range of the features described in the claims of the present application and its equivalent range.

While in the above examples, for example, the elongated first protrusions 18, 318, 418, 518, 618 extend along the circumferential direction. However, the elongated first protrusions may extend in any direction, and may extend in a direction slanted at 10° or less relative to the radial direction, for example.

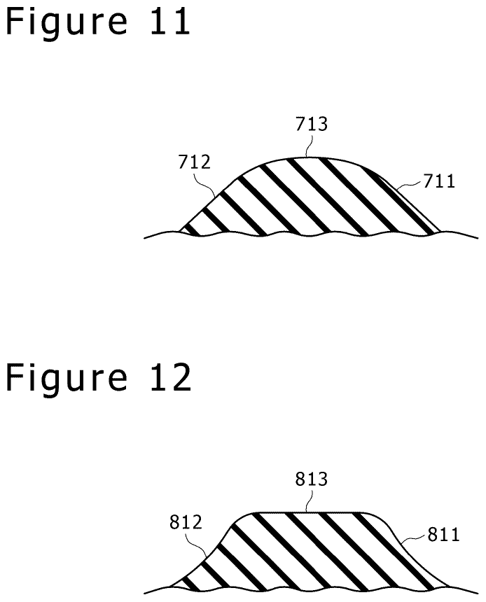

While in the examples illustrated in FIG. 1 to FIG. 4, all of the tip face 10, the first slope face 11, and the second slope face 12 of the first protrusion 18 are flat faces, one of the tip face 10, the first slope face 11, and the second slope face 12 of the first protrusion 18 may be a curved face. For example, a tip face 713 may be a curved face while two slope faces 711 and 712 may be flat faces, as illustrated in FIG. 11, or a tip face 813 may be a flat face while two slope faces 811 and 812 may be curved faces, as illustrated in FIG. 12.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A pneumatic tire, comprising:
at least one mark on a sidewall of the pneumatic tire,
the at least one mark including an outer surface having one or more and four or fewer elongated first protrusions having a trapezoidal cross sectional shape orthogonal to a traveling direction of the pneumatic tire.

2. A pneumatic tire, comprising:
at least one mark on a sidewall of the pneumatic tire,
the at least one mark including an outer surface having one or more and four or fewer elongated first protrusions having a substantially trapezoidal cross sectional shape orthogonal to a traveling direction of the pneumatic tire.

3. The pneumatic tire according to claim 1, wherein
the at least one mark comprises one or more circular second protrusions protruding axially outward on an entire edge, the at least one mark being fringed with the circular second protrusions.

4. The pneumatic tire according to claim 2, wherein
the at least mark includes one or more circular second protrusions protruding axially outward on an entire edge, the at least one mark being fringed with the circular second protrusions.

5. The pneumatic tire according to claim 1, wherein
the sidewall includes a base face and a depression disposed on the base face, and
the at least one mark is disposed on a bottom face of the depression.

6. The pneumatic tire according to claim 2, wherein
the sidewall includes a base face and a depression disposed on the base face, and
the at least one mark is disposed on a bottom face of the depression.

7. The pneumatic tire according to claim 1, wherein
the one or more and four or fewer elongated first protrusions comprise a plurality of first protrusions,
the outer surface of the at least one mark comprises the plurality of first protrusions, and
the plurality of first protrusions are opposite one another in a direction slanted at an angle of 10° or less relative to a radial direction of the at least one mark.

8. The pneumatic tire according to claim 2, wherein
the one or more and four or fewer elongated first protrusions comprise a plurality of first protrusions,
the outer surface of the at least one mark comprises the plurality of first protrusions, and
the plurality of first protrusions are opposite one another in a direction slanted at an angle of 10° or less relative to a radial direction of the at least one mark.

9. The pneumatic tire according to claim 3, wherein
the one or more circular second protrusions include an outer circular protrusion fringing an entire perimeter of an outer edge of the at least one mark and an inner circular protrusion fringing an entire perimeter of an inner edge of the at least one mark.

10. The pneumatic tire according to claim 4, wherein
the one or more circular second protrusions include an outer circular protrusion fringing an entire perimeter of an outer edge of the at least one mark and an inner circular protrusion fringing an entire perimeter of an inner edge of the at least one mark.

11. The pneumatic tire according to claim 3, wherein
an absolute value of a difference between an axial position of a tip face at an axially outermost site of the mark and an axial position of the one or more circular second protrusions at an axially outermost site is 5 mm or less.

12. The pneumatic tire according to claim 4, wherein
an absolute value of a difference between an axial position of a tip face at an axially outermost site of the mark and an axial position of the one or more circular second protrusions at an axially outermost site is 5 mm or less.

13. The pneumatic tire according to claim 2, wherein
the one or more first protrusions have a cross sectional shape orthogonal to the traveling direction, the cross sectional shape including two chamfered corners, among four corners of a trapezoid, at opposite edges of an elongated tip face that is a flat face, the two chamfered corners constituting outwardly protruding curved faces outside the two chamfered corners, respectively.

14. The pneumatic tire according to claim 2, wherein
the one or more first protrusions have a cross sectional shape orthogonal to a traveling direction, the cross sectional shape including two chamfered corners, among four corners of a trapezoid, located at a base of a trapezoid, the two chamfered corners constituting outwardly protruding curved faces outside the two chamfered corners, respectively, and
the outer surface of the at least one mark includes a flat face between bases of two first protrusions, among the first protrusions, adjacent to each other in an arranging direction of the first protrusions.

15. The pneumatic tire according to claim 2, wherein
the outer surface of the mark includes a flat face connected to a first-side base of one of the first protrusions disposed at a first end in an arranging direction of the first protrusions, the first-side base being located on a first end side in the arranging direction.

16. The pneumatic tire according to claim 2, wherein
the first protrusions include a tip face that is a curved face and two slope faces that are flat faces.

17. The pneumatic tire according to claim 2, wherein
the first protrusions include a tip face that is a flat face and two slope faces that are curved faces.
